(19) United States
(12) Patent Application Publication
(10) Pub. No.: US 2005/0225792 A1
(43) Pub. Date: Oct. 13, 2005

(54) Apparatus and method for secondarily outputting original data

(75) Inventor: Hiroyasu Morita, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/933,255

(22) Filed: Sep. 3, 2004

(30) Foreign Application Priority Data
Sep. 16, 2003 (JP) 2003-323159

(51) Int. Cl. G06F 3/12

(52) U.S. Cl. 358/1.14

(57) ABSTRACT

An original in which output permission/prohibition information is embedded and which is primarily outputted is electronically read, and it is determined based on the information whether or not secondary output of original data is permitted. Thus the secondary output of original data can be appropriately limited.

### FIELD OF THE INVENTION

This invention relates to a technique for reading an original and outputting data.

### BACKGROUND OF THE INVENTION

With the growing use of personal computers (PCs) to generate office documents, electronic data on the PCs are frequently handled as document originals. In such case, access to original electronic data is limited by, e.g., limiting users to browse and edit the original data. However, upon printing of original data on paper, the access limitation information is lost.

On the other hand, a system to read a paper original document and transmit original data using facsimile/electronic mail means or the like, such as a digital multifunction copier, has been introduced. By using this system, a large volume of printed documents can be transmitted in the form of electronic information to the outside with a simple operation.

However, once printed document is obtained, access limitation information of its original data is lost, accordingly, even unauthorized users for the original data can duplicate the printed document.

Further, there is no technique of determining based on a printed document whether or not editing of its original data has been prohibited. Furthermore, as a large volume of printed documents can be easily transmitted to the outside by using the above-described digital complex copier or the like, a problem occurs in the security protection of confidential documents.

### SUMMARY OF THE INVENTION

Accordingly, the present invention provides a technique of electronically reading an original, in which output permission/prohibition information is embedded and which is primarily outputted, then determining based on the embedded information whether or not secondary output of original data is permitted, and appropriately limiting secondary output of the original data.

In accordance with the present invention as described above, even an original generated by primarily printing from electronic data such as a document file is handled, if it is determined based on output permission/prohibition information of the electronic data that secondary output of the original is limited, secondary output of the original is limited, thereby the security of the document can be protected.

Other features and advantages of the present invention will be apparent from the following description taken in conjunction with the accompanying drawings, in which like reference characters designate the same name or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing a multifunction apparatus to which an embodiment of the present invention is applied;

FIG. 2 is a flowchart showing processing of transmitting a read original according to the embodiment;

FIG. 3 is a flowchart showing the details of processing of comparing a destination of a document designated by a user with read document information according to the embodiment;

FIG. 4 is an example of limitation information embedded in an original; and

FIG. 5 is a flowchart showing processing of transmitting a read original.

### DETAILED DESCRIPTION OF THE PREFERRED EMBODIMENTS

Preferred embodiments of the present invention will now be described in detail in accordance with the accompanying drawings.

### <FIRST EMBODIMENT>

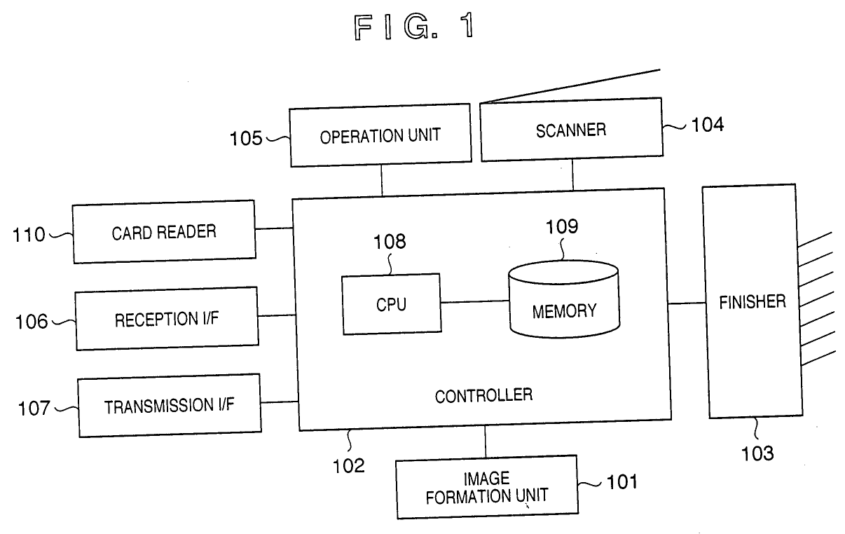

FIG. 1 is a block diagram showing a multifunction apparatus to which an embodiment of the present invention is applied.

The multifunction apparatus includes an image formation unit 101, a controller 102, a finisher 103, a scanner 104, an operation unit 105, plural reception interfaces 106 and plural transmission interfaces 107. These units are connected via specialized interfaces to the controller 102. Further, E-mail (electronic mail) transmission/reception, network file transmission, and Fax (facsimile) transmission/reception can be performed through the plural reception interfaces 106 and the plural transmission interfaces 107. Further, the controller 102 mainly has a central processing unit (CPU) 108, a storage (memory) 109 and a card reader 110.

An original, primarily outputted from an arbitrary printer or the like, is set on the scanner 104, then a transmission destination is selected with the operation unit 105 and transmission can be designated. At this time, the transmission destination is newly set or selected from destinations already set in the form of address book.

In this example, output of original document file or image file to a medium such as paper is referred to as primary output. Further, electronically reading of original, formed by primary output, and duplicating, storing as a file, or sending via facsimile transmission or transmission as attachment to an electronic mail, is referred to as secondary output.

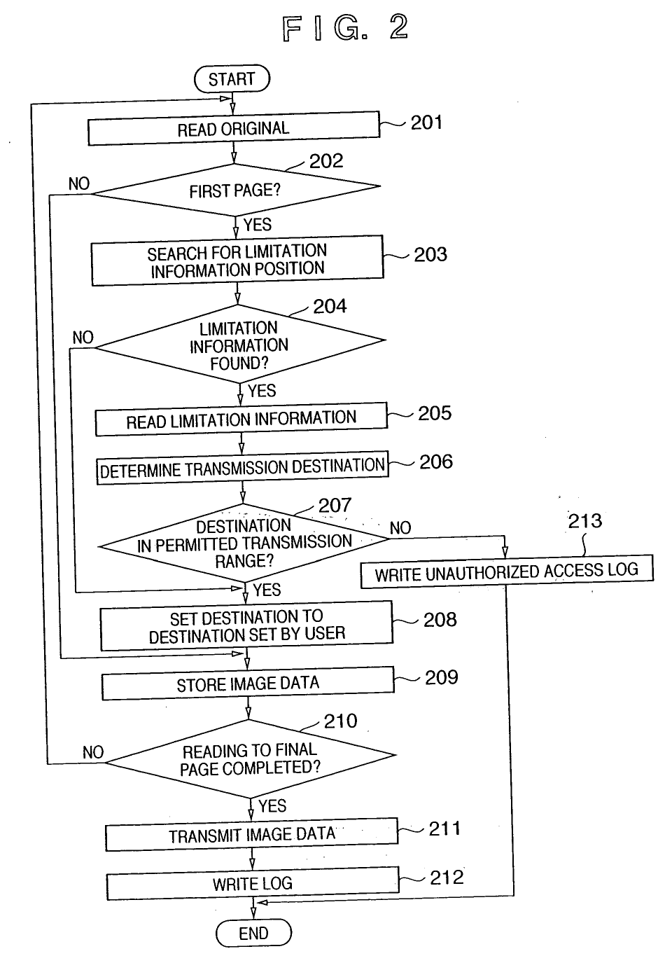

FIG. 2 is a flowchart showing processing of transmitting a read original according to the present embodiment.

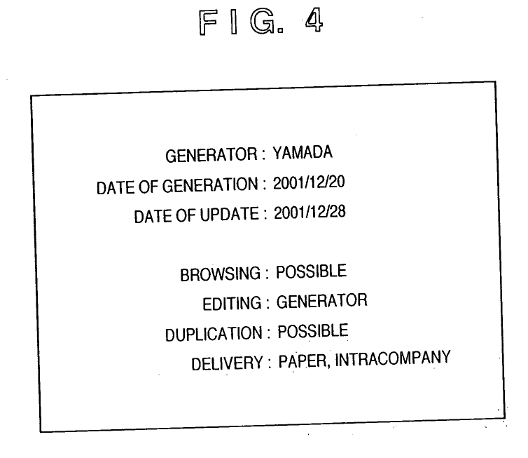

First, an original set on the scanner 104 is electronically read, and the CPU 108 generates electronic data (step 201). The CPU 108 determines whether or not the read original corresponds to a first sheet (first page) of the original set at step 201 (step 202). The determination is made on the premise that limitation information indicating permission/prohibition of secondary output is embedded in the first sheet of the original. If YES in the determination at step 202, the CPU 108 searches for the position of limitation information in image data of the read original (step 203). The CPU 108 determines whether or not limitation information (see FIG. 4) is embedded in the position (step 204). If YES in the determination at step 204, limitation information is read from the position and character recognition is performed (step 205).

Next, the CPU 108 compares the destination of the document designated by a user with the read limitation information (step 206). The CPU 108 determines whether or not the designated destination corresponds to a destination permitted in the limitation information (step 207). If YES in the determination at step 207, the CPU 108 sets the transmission destination of the original to the destination set by the user (step 208). The CPU 108 stores the read image data in the memory 109 (step 209). Note that if NO in the determination at step 202, the process proceeds to step 209. If NO in the determination at step 204, the process proceeds to step 208. If NO in the determination at step 207, the CPU 108 records the fact that the processing request has been made for the unauthorized destination in a history (unauthorized access log) (step 213), and the process ends.

Next, the CPU 108 determines whether or not reading to a final page of the original set on the scanner 104 has been completed (step 210). If YES in the determination at step 210, the CPU 108 transmits the image data stored at step 209 to the transmission destination set at step 208 (step 211). The CPU 108 records a transmission history (transmission log) in the memory 109 (step 212), and the process ends. If NO in the determination at step 210, the process returns to step 201.

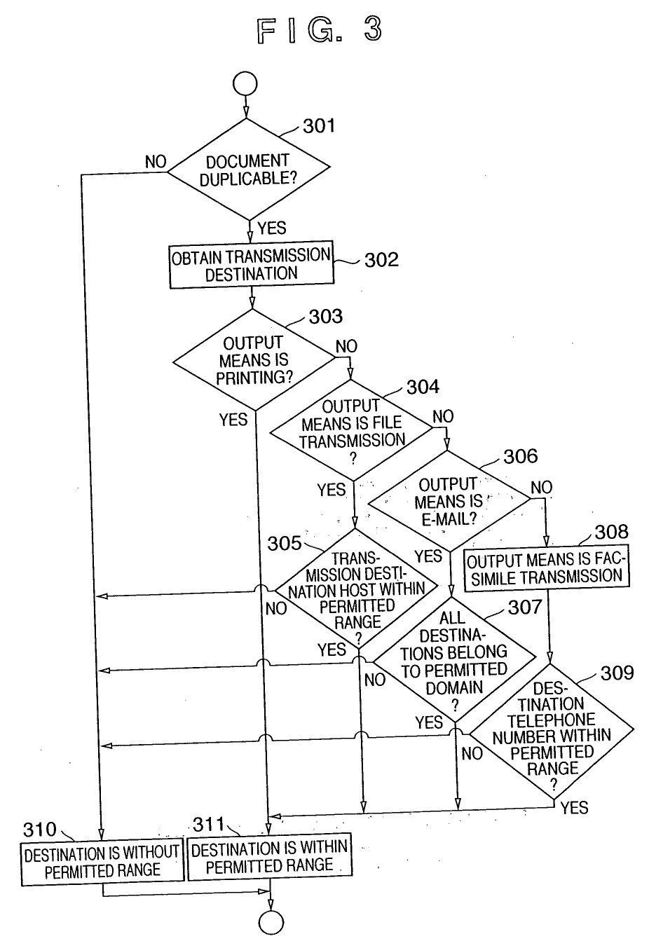

FIG. 3 is a flowchart showing the details of processing of comparing the destination of the document designated by the user with the read document information (step 206) in the present embodiment.

First, the CPU 108 refers to the limitation information read at step 205, and determines whether or not the document is duplicable (step 301). If NO in the determination at step 301, the CPU 108 generates a determination result indicating that the document designated by the user is a transmission-unpermitted document and stores it in the memory 109 or the like (step 310), and the process proceeds to step 207.

If YES in the determination at step 301, the CPU 108 obtains the transmission destination designated by the user with the operation unit 105 (step 302). The transmission destination is information from which output means can be indirectly discriminated, such as an electronic-mail address or a facsimile number. It may be arranged such that output means designation information to designate output means is inputted from the operation unit 105 and then a particular transmission destination is inputted. In this case, desired output means can be directly discriminated in accordance with the output means designation information.

The CPU 108 determines in accordance with information on the obtained transmission destination (or the output means designation information) whether or not the output means corresponding to the designated destination is printing means (step 303). If YES in the determination at step 303, the CPU 108 generates a determination result indicating that transmission to the destination designated by the user is permitted, and stores it in the memory 109 or the like (step 311), and then the process proceeds to step 207.

If NO in the determination at step 303, the CPU 108 determines in accordance with the information on the obtained transmission destination (or the output means designation information) whether or not the output means capable of transmitting the original to the designated destination is file transmission means (step 304). If YES in the determination at step 304, the CPU 108 determines whether or not the destination host obtained at step 302 is within a permitted range in the limitation information (step 305). If YES in the determination at step 305, the CPU 108 generates a determination result indicating that transmission to the destination designated by the user is permitted (step 311). On the other hand, if NO in the determination at step 305, the CPU 108 generates a determination result indicating that transmission to the destination designated by the user is prohibited (step 310), and then the process proceeds to step 207.

If NO in the determination at step 304, the CPU 108 determines in accordance with the information on the obtained transmission destination (or the output means designation information) whether or not the output means capable of transmitting the original to the designated destination is E-mail transmission means (step 306). If YES in the determination at step 306, the CPU determines whether or not all the transmission destinations obtained at step 302 belong to a domain permitted in the limitation information (step 307). Note that the limitation information includes information to specify a transmission-permitted domain. If YES in the determination at step 307, the CPU 108 generates a determination result indicating that transmission to the destination designated by the user is permitted (step 311). If NO, the CPU 108 generates a determination result indicating that transmission to the destination designated by the user is prohibited (step 310), and then the process proceeds to step 207.

If NO in the determination at step 306, the CPU 108 determines that the output means capable of transmitting the original to the designated destination is Fax (facsimile) transmission means (step 308). Next, the CPU 108 determines whether or not all the transmission telephone numbers obtained at step 302 belong to a permitted range in the limitation information (step 309). Note that the limitation information includes information to specify a telephone number with permission to receive the original with embedded limitation information. If YES in the determination at step 309, the CPU 108 generates a determination result indicating that transmission to the destination designated by the user is permitted (step 311). On the other hand, if NO in the determination at step 309, the CPU 108 generates a determination result indicating that transmission to the destination designated by the user is prohibited (step 310), and then the process proceeds to step 207.

As described above, an original can be transmitted to different types of output means (file transmission means, electronic-mail transmission means or facsimile transmission means) in correspondence with a designated transmission destination (output destination).

FIG. 4 is an example of limitation information (output permission information) embedded in an original. The limitation information includes, e.g., information on an original generator, information on original generation date and update date, information indicating whether or not the original can be browsed by a third person, information to limit editing-permitted user such as “editing: generator”, information indicating whether or not duplication of the original is permitted such as “duplicable”, and information on delivery format such as “delivery: paper, intracompany”.

The limited information is embedded in the original and print-outputted. For example, in a personal computer, if an original including limitation information on output permission is generated and printing is designated, the limitation information is converted to image data and embedded in the original by a printer driver or original-generation application. As an image data embedding technique, a well-known technique such as electronic watermark, one-dimensional bar code or two-dimensional bar code is employed. In this manner, the printer or image formation unit in FIG. 1, which receives a print job from the personal computer, print-outputs the original with the limitation information embedded therein.

In FIG. 2, at step 201, the printed original is read by the scanner 104, and image data is generated. At step 205, character recognition is performed based on the image data of the limitation information, then text data is generated, and the contents of the limitation information are recognized. If “duplication: possible” is described as limitation information, it is determined at step 301 in FIG. 3 that the document is duplicable. In addition to the above information, the permitted range of transmission destination host at step 305, the permitted domain of destination at step 307, and the permitted range of destination telephone number at step 309, and the like, are described in the limitation information.

It is preferable that the limitation information is described in the first page of single or plural pages of original, however, the limitation information may be described in another page as long as output of the original can be appropriately limited. For example, in an apparatus to perform original reading and output processing in parallel, it is preferable that the limitation information is included in an initial page, for prevention of degradation of parallel processing efficiency or output of a part of pages. In an apparatus to temporarily store all the original before output processing, the limitation information may be included in any page of the original.

According to the present embodiment, even a document which was once printed on paper is handled, an operation prohibited in limitation information (output permission information) of original data cannot be performed, thus security can be protected.

### <SECOND EMBODIMENT>

In addition to the first embodiment, it may be arranged such that in a system, if a destination is a permission-prohibited destination, image information of original to which unauthorized access has been made is held.

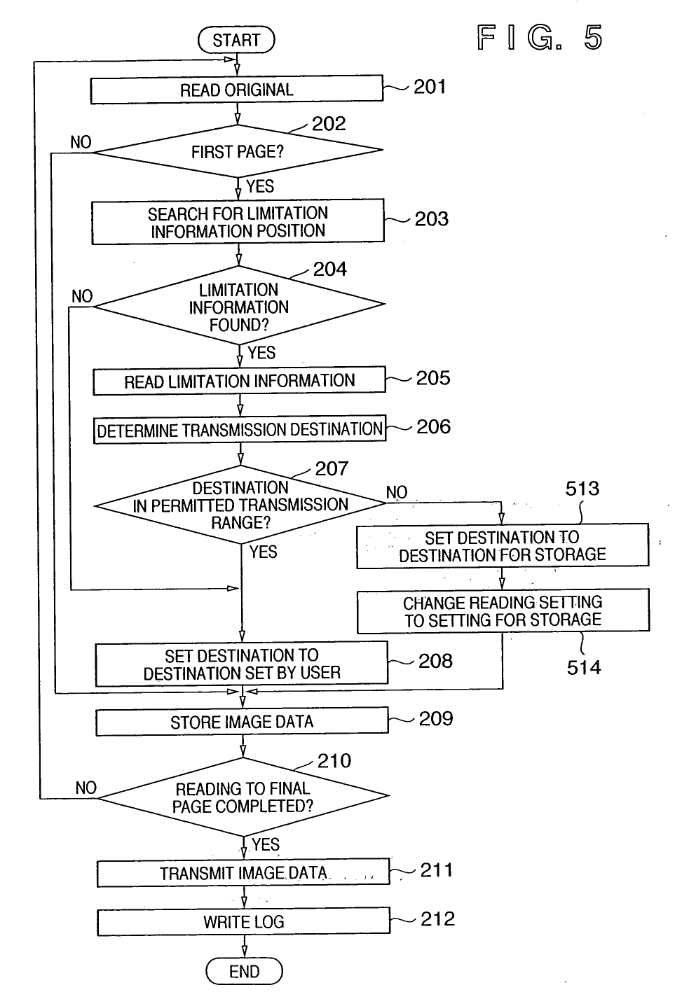

FIG. 5 is a flowchart showing processing of transmitting a read original according to a second embodiment of the present invention. Note that for the sake of simplification, processings corresponding to those in FIG. 3 have the same reference numerals.

As described above, steps 201 to 207 are performed. Then if NO in the determination at step 207, the process proceeds to step 513, at which the CPU 108 sets the transmission destination of the original to a destination for image storage previously set in the system (unpermitted data storage unit). The destination for image storage is a particular folder in the internal memory 109, a folder in an external file server, a facsimile number, or an administrator's mail address. Accordingly, the storage of unpermitted original data in storage unit is a concept including facsimile transmission and electronic-mail transmission.

At step 514, the CPU 108 changes the reading setting in the scanner 104 to reading setting for image storage previously set in the system (unpermitted data reading setting), and the process proceeds to step 209. From the next page, the original is read in accordance with the reading setting for image storage.

According to the present embodiment, if an operation prohibited in limitation information (output permission/prohibition information) of original data has been made, image information of the original and the operation are recorded. Thus, the security can be more effectively protected.

As described above, according to the first and second embodiments, the controller 102 controls the scanner 104, to read a primarily-outputted original and generate electronic original data. Note that the apparatus of the embodiments has plural output units to output the generated original data in different forms. The image formation unit 101 for print output, the transmission I/F 107 for facsimile or electronic-mail transmission, and the memory 109 for file storage correspond to the output units. The controller 102 recognizes limitation information on output permission/prohibition from the original data. For example, a search is made for an embedded position of limitation information in the original, and the limitation information embedded in the position as electronic watermark, bar code or the like is character-recognized. The controller 102 determines in accordance with the recognized output permission/prohibition information whether or not secondary output of the original data is permitted. If the CPU 102 determines that the secondary output of the original data is permitted, the controller 102 controls a desired one of the plural output units to output the original data. On the other hand, if the controller 102 determines that secondary output of the original data is not permitted, the controller 102 prohibits secondary output of the original data.

As described above, secondary output of original data can be appropriately limited.

Further, if an output destination designated by the user is without a permitted range in the limitation information of the original data, the controller 102 performs setting so as to store the original data (original image information) into a predetermined storage unit. The storage unit is not necessarily provided in the apparatus. For example, the storage unit may be an external file server or a mail server to spool mails to an administrator. Further, all the pages of the original data may be stored in the storage unit, otherwise, a page read after the determination of prohibition of secondary output may be stored in the storage unit. By the above storage, even if the original document data is once printed on paper, a secondary output operation prohibited in the limitation information of the original document data can be effectively prohibited, thus the security can be protected.

Further, in the second embodiment, in a case where an operation prohibited in limitation information of original data has been made, the image information of the original and the operation are recorded, thus the security can be more effectively protected.

Note that an example of an apparatus to primarily output original data will be described. The apparatus in FIG. 1 stores original data and an electronic file including information on output permission/prohibition of the original data into the memory 109. The CPU 108 receives a print command for the original data from the operation unit 105, then reads the output permission/prohibition information from the electronic file. The CPU 108 generates print job data to embed the output permission/prohibition information into the original data and print the original data, and outputs the data to the image formation unit 101. The embedding is made by using electronic watermark, bar code or the like. The position of embedded information may be set in a predetermined position. The image formation unit 101 print-outputs the original in which the output permission/prohibition information is embedded, based on the print job data. Thus secondary output of the original can be effectively limited. Note that the processings other than processing by the image formation unit 101 may be performed on an external PC.

### <OTHER EMBODIMENTS>

Note that the present invention can be applied to an apparatus comprising a single device or to system constituted by a plurality of devices.

Furthermore, the invention can be implemented by supplying a software program, which implements the functions of the foregoing embodiments, directly or indirectly to a system or apparatus, reading the supplied program code with a computer of the system or apparatus, and then executing the program code. In this case, so long as the system or apparatus has the functions of the program, the mode of implementation need not rely upon a program.

Accordingly, since the functions of the present invention are implemented by computer, the program code itself installed in the computer also implements the present invention. In other words, the claims of the present invention also cover a computer program for the purpose of implementing the functions of the present invention.

In this case, so long as the system or apparatus has the functions of the program, the program may be executed in any form, e.g., as object code, a program executed by an interpreter, or scrip data supplied to an operating system.

Example of storage media that can be used for supplying the program are a floppy disk, a hard disk, an optical disk, a magneto-optical disk, a CD-ROM, a CD-R, a CD-RW, a magnetic tape, a non-volatile type memory card, a ROM, and a DVD (DVD-ROM and a DVD-R).

As for the method of supplying the program, a client computer can be connected to a website on the Internet using a browser of the client computer, and the computer program of the present invention or an automatically-installable compressed file of the program can be downloaded to a recording medium such as a hard disk. Further, the program of the present invention can be supplied by dividing the program code constituting the program into a plurality of files and downloading the files from different websites. In other words, a WWW (World Wide Web) server that downloads, to multiple users, the program files that implement the functions of the present invention by computer is also covered by the claims of the present invention.

Further, it is also possible to encrypt and store the program of the present invention on a storage medium such as a CD-ROM, distribute the storage medium to users, allow users who meet certain requirements to download decryption key information from a website via the Internet, and allow these users to decrypt the encrypted program by using the key information, whereby the program is installed in the user computer.

Furthermore, besides the case where the aforesaid functions according to the embodiments are implemented by executing the read program by computer, an operating system or the like running on the computer may perform all or a part of the actual processing so that the functions of the foregoing embodiments can be implemented by this processing.

Furthermore, after the program read from the storage medium is written to a function expansion board inserted into the computer or to a memory provided in a function expansion unit connected to the computer, a CPU or the like mounted on the function expansion board or function expansion unit performs all or a part of the actual processing so that the functions of the foregoing embodiments can be implemented by this processing.

As many apparently widely different embodiments of the present invention can be made without departing from the spirit and scope thereof, it is to be understood that the invention is not limited to the specific embodiments thereof except as defined in the appended claims.

### CLAIM OF PRIORITY

This application claims priority from Japanese Patent Application No. 2003-323159 filed on Sep. 16, 2003, which is hereby incorporated by reference herein.

1. An apparatus for secondarily outputting original data, comprising:
a generation unit to electronically read a primarily outputted original and generate electronic original data;
a plurality of output units to output said generated original data in different forms respectively;
a recognition unit to recognize output permission/prohibition information of said original data from said original data;
a determination unit to determine in accordance with said recognized output permission/prohibition information whether or not secondary output of said original data is permitted; and
a control unit to, if it is determined that the secondary output of said original data is permitted, control desired one of said plurality of output units to output said original data, while if it is determined that the secondary output of said original data is not permitted, prohibit the secondary output of said original data.

2. The apparatus according to claim 1, further including a storage unit to store said original data if said determination unit determines that the secondary output of said original data is not permitted.

3. The apparatus according to claim 1, wherein said output units are at least two of printing means, file transmission means, electronic-mail transmission means and facsimile transmission means.

4. The apparatus according to claim 3, further including a storage unit to store said original data if said determination unit determines that the secondary output of said original data is not permitted.

5. The apparatus according to claim 1, further including a designation unit to designate a desired output destination,
wherein said determination unit determines in accordance with said output permission/prohibition information whether or not the secondary output of said original data by said output unit corresponding to said designated output destination is permitted.

6. The apparatus according to claim 5, wherein said output unit is file transmission means, electronic-mail transmission means or facsimile transmission means.

7. The apparatus according to claim 5, further including a storage unit to store said original data if said determination unit determines that the secondary output of said original data is not permitted.

8. The apparatus according to claim 7, wherein if it is determined that the secondary output of said original data is not permitted, said control unit outputs said original data from the next page to said storage unit regardless of said designated output destination.

9. A method for secondarily outputting original data, comprising:
a step of electronically reading a primarily outputted original and generating electronic original data;
a step of recognizing output permission/prohibition information of said original data from said original data;
a step of determining in accordance with said recognized output permission/prohibition information whether or not secondary output of said original data is permitted; and
a step of, if it is determined that the secondary output of said original data is permitted, controlling desired one of plural output units to output said original data; and
a step of, if it is determined that the secondary output of said original data is not permitted, prohibiting the secondary output of said original data.

10. The method according to claim 9, further including a step of storing said original data if it is determined that the secondary output of said original data is not permitted.

11. The method according to claim 9, wherein said output units are at least two of printing means, file transmission means, electronic-mail transmission means and facsimile transmission means.

12. The method according to claim 11, further including a step of storing said original data if it is determined that the secondary output of said original data is not permitted.

13. The method according to claim 9, further including a step of designating a desired output destination,
wherein at said determination step, it is determined in accordance with said output permission/prohibition information whether or not the secondary output of said original data by said output unit corresponding to said designated output destination is permitted.

14. The method according to claim 13, wherein said output units is file transmission means, electronic-mail transmission means or facsimile transmission means.

15. The method according to claim 13, further including a step of storing said original data if it is determined that the secondary output of said original data is not permitted.

16. The method according to claim 15, further including a step of, if it is determined that the secondary output of said original data is not permitted, outputting said original data from the next page to said storage unit regardless of said designated output destination.

17. An apparatus for primarily outputting original data, comprising:
a storage unit to store original data and an electronic file including output permission/prohibition information of said original data;
a reception unit to receive a print command for said original data;
a reading unit to read said output permission/prohibition information from said electronic file;
a generation unit to generate print job data to embed said read output permission/prohibition information in said original data and print said original data; and
a print unit to perform printing based on said print job data.
